(19) United States
(12) Patent Application Publication
(10) Pub. No.: US 2003/0152434 A1
(43) Pub. Date: Aug. 14, 2003

(54) Machine tool head, a machine tool and a method for working an object

(76) Inventors: Robert Forlani, Dianella (AU); David Russell Herbert, Rockingham (AU)

Correspondence Address: MARGER JOHNSON & MCCOLLOM PC, 1030 SW MORRISON STREET, PORTLAND, OR, 97205, US

(21) Appl. No.: 10/220,987

(22) PCT Filed: Mar. 7, 2001
(86) PCT No.: PCT/AU01/00245

(30) Foreign Application Priority Data
Mar. 7, 2000 (AU) PQ 6091

(51) Int. Cl. B23C 1/00

(52) U.S. Cl. 409/235

(57) ABSTRACT

A multiple-axis machine (11) for working on an object (131) and a machine tool head (27) therefor. The machine (11) includes abase (13) housing an annular bearing (19), which has a central axis (21) along which the object (131) being be worked on is disposed. A ring journal (23) is concentrically and rotatably disposed within the bearing (19). A journal drive (25) is mounted to the bearing (19) for engaging and controlledly driving the ring journal (23) in rotation or counter-rotation relative to the bearing (19). The machine tool head (27) includes a holder (73) for a tool (85) to be connected thereto for working the object (131) and three fingers (75) for engaging and supporting the holder (73) in a variety of orientations relative to a main axis or plane of the object (131). Three corresponding cylinders and barrels (77) are provided for accommodating and changing the position of the fingers (75) to orient the holder (73) relative to the main axis or plane in any of the variety of orientations. A drive (79) is provided for extending and retracting the fingers (75) and varying the orientation of the holder (73) in a controlled manner with respect to the pitch, bank and extension of thereof relative to the main axis. The head (27) is fixedly mounted to the ring journal (23) so that the holder (73) is disposed radially of the ring journal (23) to present the tool (85) in a manner so as to perform a material treatment of the object (131), when the object is disposed with its main axis coaxial with the central axis (21), at an orientation to the surface of the object prescribed by the orientating means (77). A method for working an object is also described.

### FIELD OF THE INVENTION

This invention relates to a machine tool head, a machine tool and a method for working an object. In this specification, the following terms are specifically defined as indicated:

“machine tool” is defined to mean any machine specifically designed to treat or act upon an object with tooling so as to effect an inspection or material treatment of the object;

“machine tool head” is defined to mean that part of the machine to which the tool is attached and is moved by the machine to work an object disposed relative to the machine;

“tool” is defined to mean anything that is attached to the machine tool head that is intended to work the object;

“material treatment” is defined to mean any type of treatment or action upon an object, including marking, painting, coating or depositing any material on an object, measuring, finishing, adjusting, cutting, drilling, punching, machining, depositing, electro-discharging, magnetising or demagnetising, abrading, colouring, chemical treatment, cleaning or washing, light or radiation exposure, hardening, annealing, heating or cooling, fastening, threading, milling, piercing, ultrasonic measuring or treating, radiating, or any other object working or standard machine function, and any combination of the same;

“computer file” is defined to mean any type of computer information or data storage and retrieval means or methodology, including any three dimensional solid file format and the storage and retrieval methodology described in the complete specifications for Australian Patent Applications 48716/96 and 59391/99.

Throughout the specification, unless the context requires otherwise, the word “comprise” or variations such as “comprises” or “comprising”, will be understood to imply the inclusion of a stated integer or group of integers but not the exclusion of any other integer or group of integers.

The technical field to which the invention relates is in the material treatment or working of objects using a machine tool, including the use of such machine tools in computer numerically controlled (CNC) machines. Accordingly the invention finds utility with any working process of an object involving use of a tool in a controlled manner, whereby the tool provides a prescribed material treatment of the object and where manoeuvrability and dexterity of the tool relative to the object is a requirement.

The invention finds particular utility in the provision of multi-axis control machine tools, and especially in five or six-axis machine tools.

### BACKGROUND ART

Machine tools that can provide five-axis control of a tool are generally found in robots that are able to achieve the degree of manoeuvrability required to perform material treatment or welding functions. Robotsfind limited utility in mechanical workshops, manufacturing facilities or the like for small to medium size enterprises involved with the material treatment of articles. Whilst CNC machines are particularly useful and find favour with small to medium size enterprises of the type described compared to the time consuming teach and play methods involved with using and training robots, they have been limited somewhat with the degree of manoeuvrability and dexterity that can be achieved with them. Moreover, in order to achieve anywhere near the degree of flexibility that can be achieved with a robot, a CNC machine needs to be of at least the five-axis type, ie the machine tool head is required to be able to move in any of five different axes in three dimensional space relative to an object being worked on.

Whilst five-axes machinery under computer control is widely used in a variety of applications and is adequate for most jobs involving the material treatment of articles, certain jobs require an extra degree of flexibility or dexterity not provided by five-axes machines of currently known design. For example, it may be necessary to achieve an orthogonal cut on all four sides of a rectangular hollow section (RHS) of material, and then an internal bevel cut on two sides, and/or another material treatment function. At present, five-axes machines of known design are not capable of providing such functionality for a reasonable cost or in a convenient manner.

### DISCLOSURE OF THE INVENTION

Accordingly, it is an object of the present invention to provide for the material treatment of an article in a simple and cost effective manner.

It is a preferred object of the invention to provide a machine tool head that enables a degree of extra flexibility and manoeuvrability than is capable of being provided by known designs of five-axes machine tools.

In accordance with a first aspect of the present invention, there is provided a machine tool head for working on an object comprising:

a holder for a tool to be connected to the machine tool head that works the object;

a holder engaging means for engaging and supporting said holder in a variety of orientations relative to a main axis or plane of the object;

orientating means for changing the position of said holder engaging means so as to orient said holder relative to said main axis or plane in any of said orientations;

drive means for driving said orientating means and varying the orientation of the holder in a controlled manner; and

mounting means for mounting the machine tool head to a head supporting member.

Preferably, said holder is formed to define a main plane and has a tool connection for connecting a tool thereto in fixed orientation to said main plane; and said holder engaging means comprises a plurality of fingers each universally jointed to said holder so that the joints are disposed in coplanar relationship with said main plane.

Preferably, said orientating means comprises a plurality of cylinders and barrels one for each said finger, to axially move a said finger independently of the other, relative to said barrels.

Preferably, a corresponding barrel and cylinder pair are disposed in coaxial relationship with each other and a corresponding finger, and all of said pairs are disposed in parallel relationship with each other.

Preferably, said drive means comprises a gearing and screw drive driven by a dedicated servo motor for each pair, each said servo motor being individually and precisely controlled to rotate or counter-rotate a screw shaft via gearing to axially extend or retract a said finger and cylinder relative to a said barrel thereof.

Preferably, there are three pairs of corresponding fingers, cylinders and barrels providing three axes of movement of said holder (and hence the tool), allowing for precise control of, and complete dexterity in, the movement of said holder with respect to pitch, bank and extension relative to said main axis.

In accordance with a second aspect of the present invention, there is provided a multiple-axis machine for working on an object comprising:

a base housing an annular bearing having a central axis along which an object to be worked on may be disposed;

a ring journal, concentrically and rotatably disposed within said bearing to be rotated or counter-rotated relative to said bearing; journal drive means mounted to said annular bearing to engage and controlledly drive said ring journal in rotation or counter-rotation relative to said bearing;

a machine tool head substantially as defined in the preceding aspect of the invention, fixedly mounted to said ring journal so that the holder is disposed radially of said ring journal to present a tool for performing a material treatment of an object disposed with its main axis coaxial with said central axis, at an orientation to the surface of the object prescribed by said orientation means.

Preferably, the ring journal has a driven gear portion circumferentially disposed at one end thereof and said journal drive means has a driving gear portion intermeshing with said driven gear portion to effect said rotation or counter-rotation of said ring journal relative to said bearing.

Preferably, said base is mounted to a carriage axially moveable along a track axis, whereby the track axis is parallel with the central axis of said bearing. Alternatively, or additionally, the machine includes an object feeding means to support the object with its main axis coincident with said central axis, and move said object axially along the main and central axis relative to said base.

In accordance with a further aspect of the present invention, there is provided a method for working an object having a main axis to provide a material treatment thereof comprising:

disposing the object so that its main axis is coincident with a central axis about which the material treatment is performed;

holding a tool to perform the material treatment at a prescribed radial orientation relative to the object and the main and central axes;

moving the tool relative to said object around the entire circumference of the object as necessary in a direction transverse to said central axis; and

continuously varying the orientation of the tool relative to the object in accordance with a predetermined control program as necessary to effect the material treatment.

Preferably, the tool is oriented in three-dimensional space having three-axes of movement permitting precise control of, and complete dexterity in, the movement of the tool in its radial disposition relative to the object with respect to pitch, back and extension.

Preferably, the tool is further oriented in three-dimensional space having two further axes of movement relative to the object, one being rotational so that the tool may entirely circumscribe the object about said central axis and the other being rectilinear, parallel to said central axis, so that the tool may traverse the surface of the object axially relative to its main axis.

### BRIEF DESCRIPTION OF THE DRAWINGS

The invention will be better understood in the light of the following description of one specific embodiment thereof. The description is made with reference to the following drawings, wherein:

FIG. 1 is a perspective view showing the machine tool encaged within the sub-frame and treating a metal section in the form of an I-beam;

FIGS. 2 and 2′ are lined and solid front perspective views, respectively, of the machine tool fitted with the outer cover, showing a cylindrical object disposed therein for material treatment;

FIGS. 3 and 3′ are lined and solid rear perspective views, respectively, of FIGS. 2 and 2′;

FIGS. 4 and 4A are lined and solid rear perspective views, respectively, of the base, annular bearing and journal dive means of the machine tool;

FIG. 5 is a top perspective view showing the journal drive means with the outer cover removed;

FIGS. 6 and 6′ are lined and solid fragmentary perspective views, respectively, showing how the ring journal and machine tool head are interconnected;

FIGS. 7 and 7′ are lined and solid views, respectively, similar to FIGS. 6 and 6′, but from a broader perspective;

FIGS. 8 and 8′ are lined and solid rear perspective views, respectively, similar to FIGS. 3 and 3′, but with the outer cover removed and the machine tool head in a different orientation;

FIG. 9 is an exploded rear perspective view showing the ring journal and machine tool head assembly on the one part separated from the base, annular bearing and journal drive assembly on the other part, in their correct perspective;

FIGS. 10A to 10D show various views of the machine tool without any object in position for material treatment, with the leading outer cover removed in FIG. 10A, and the machine head tool cover removed in FIG. 10C;

FIG. 11 is a perspective view showing how the holder engaging means and the holder are interconnected;

FIGS. 12A and 12B are fragmentary perspective views showing the tool and holder in different angular orientations;

FIG. 13A is a perspective view showing an arm and cylinder of the machine tool head, with the arm extended;

FIG. 13B is a similar view to FIG. 2, but showing the arm retracted;

FIG. 14 is a perspective view of the machine tool head;

FIG. 15 is a top perspective view of FIG. 14;

FIG. 16 is a perspective view showing a machine tool system with in-feeding and out-feeding conveyor systems and in-loading and out-loading stations;

FIGS. 17A and 17A′ are lined and solid perspective views, respectively, of a pipe cut and bevelled for welding;

FIGS. 17B and 17B′ are lined and solid perspective views, respectively, of a pipe that is cross-cut;

FIGS. 17C and 17C′ are lined and solid perspective views, respectively, of a pipe that is cross-cut and bevelled;

FIGS. 17D and 17D′ are lined and solid perspective views, respectively, of a rolled gutter piece cut to length and cut with a mitred end;

FIGS. 17E and 17E′ are lined and solid perspective views, respectively, showing a piece of cut to length angle iron, having a number of unusual cuts that are capable of being performed by the apparatus described in the embodiment, but which are not all able to be performed using prior known five-axes machines; and

FIG. 17F is a perspective view of an RHS, mitre cut at one end and formed with laterally extending holes on two opposing sides thereof.

### BEST MODE(S) FOR CARRYING OUT THE INVENTION

The embodiment of the invention is directed towards a five-axis machine tool of the CNC type having a machine tool head that presents a tool to an object for material treatment thereof.

The object in the present embodiment is a metal section of constant cross section and of long length. Long in this sense is defined to be where the length is about five times any other dimension. Accordingly, the embodiment makes reference to the material treatment of metal sections in the form of tubes, pipes, rectangular or square and other hollow sections, angle, I-beams and complex U-shaped channels such as guttering.

The tool used in the present embodiment is a cutting tool for cutting the metal section to prescribed lengths and for performing particular material treatments such as cutting the section in a mitre or compound mitre, cutting a bevel on the outside or the inside surface of the section, cutting holes or slots of any shape in the section at any point along its length and cutting notches in the ends of the section of any particular shape.

The cutting tool for performing such material treatments in the present embodiment is a plasma or oxy-propane cutting head.

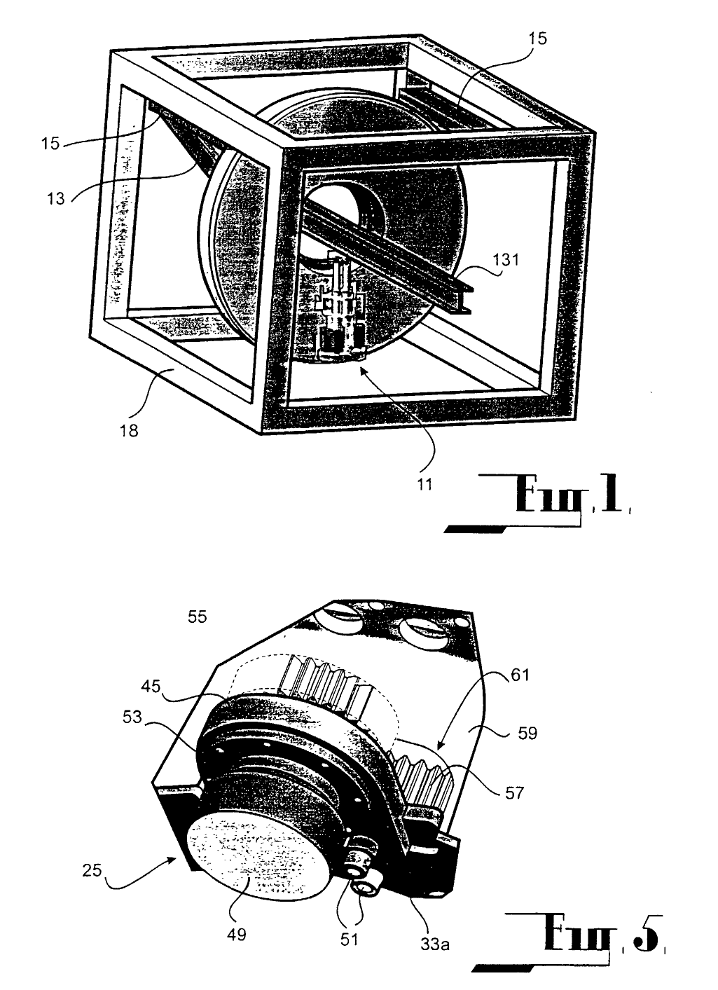

As shown in the drawings the machine tool 11 has a base 13 affixed to a pair of carriage portions 15 which are adapted to move axially along a pair of tracks (not shown) defining a pair of track axes 17. The tracks are mounted to the top of a rectangular sub-frame 18 from which the machine tool 11 is suspended, so that the machine tool is essentially encaged within the sub-frame, as shown in FIG. 1 of the drawings.

The base 13 houses an annular bearing 19 having a central axis 21, which forms the main axis of the machine tools, and accommodates a ring journal 23 concentrically therein.

The machine tool 11 also includes a journal drive means in the form of a positioning gearmotor 25 mounted to the annular bearing 19 to engage and drive the ring journal 23 in rotation or counter-rotation relative to the bearing.

A machine tool head 27 is fixedly mounted to the ring journal 23 in an essentially radial position relative to the central axis 21 of the annular bearing 19.

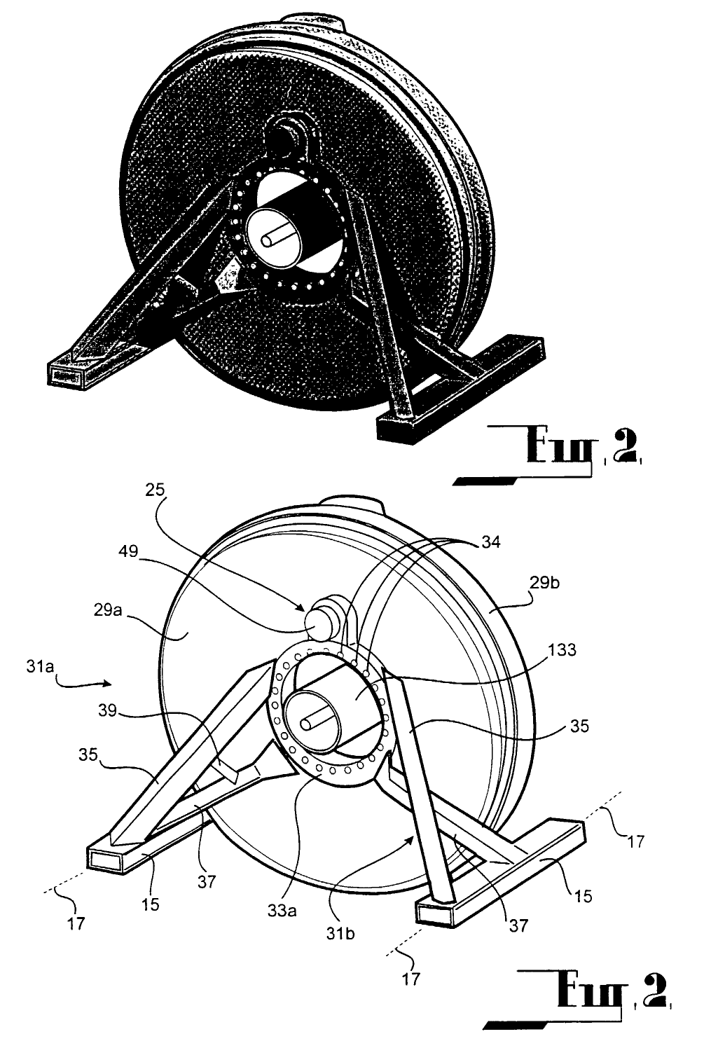

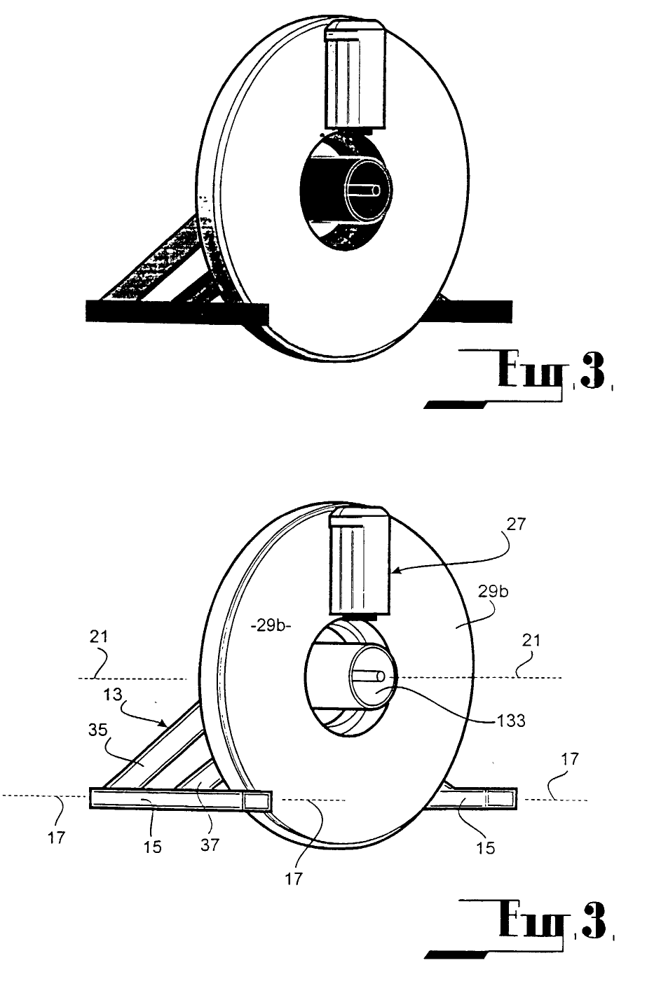

The annular bearing 19 is attached to a leading outer cover 29a, which forms one half of an annular cover 29, and the ring journal 23 is connected to a trailing outer cover 29b, which forms the other opposing half of the outer cover. The outer covers are oppositely disposed to confront each other, whereby the leading outer cover 29a is accommodated within the trailing outer cover 29b in a close fitting but marginally spaced relationship to enable rotation of the trailing outer cover 29b relative to the leading outer cover 29a, as shown in FIGS. 2 to 3′ and 10A to 10D. Accordingly, the trailing outer cover 29b rotates relative to the leading outer cover 29a with the greater parts of the bearing 19 and journal 23 accommodated within the annulus formed by the overall cover 29.

The base 13 essentially comprises two pairs of supporting legs 31, one pair of legs being disposed at either side of the central axis 21. Each pair of legs 31 forms a frame fixedly attached to the annular bearing 19 at one end and to the respective carriage portions 15 at the other end. The bearing 19 has an outer flange 33 disposed at the leading side of the machine tool to which the inner ends of each framework 31 of the supporting arms are fixedly attached.

The framework 31 comprises a main outer leg 35, a main inner leg 37 and an intermediate supporting strut 39. The inner ends of the main legs 35 are each welded to either side of the flange 33 with respect to the vertical and on the same side of the flange relative to the horizontal. As shown in FIGS. 2 to 3′, this same side is the upper side of the flange 33. The main legs 35 extend divergently outwardly from the flange 33 relative to the central axis 21, towards the opposite side of the flange relative to the horizontal, in an oblique manner so that the outer ends thereof are fixedly connected to the respective carriage portions 15 by welding.

The carriage portions 15 each comprise discrete lengths of RHS, which are disposed in parallel arrangement to each other and to the central axis 21. The carriage portions 15 are equidistant from the central axis and are sufficiently spaced therefrom to clear the outer circumference of the cover 29. Accordingly, the distance between each of the carriage portions 15 and the central axis 21 is greater than the radius of the cover 29.

Each of the inner legs 37 is similarly disposed to the outer legs 35, the inner ends thereof being fixedly mounted by welding to either side of the flange 33 about the vertical, and to the same side of the flange about the horizontal, but oppositely compared with the outer leg. In the case shown in FIGS. 2 to 3′, this same side is the lower side of the flange 33 with respect to the horizontal about the central axis 21.

The inner legs 37 also extend in an outwardly diverging manner to the leading side of the machine tool, but at a lesser oblique angle than the outer legs 35. Accordingly, the distal ends of the inner legs 37 engage the carriage portions 15 at an intermediate and more proximal position to the cover 29 compared with the outer legs 35. The outer ends of the inner legs 37 are similarly welded to the carriage portions 15.

The cross struts 39 are fixedly attached by welding at opposite ends thereto to intermediate portions of corresponding outer and inner legs so as to brace the respective frame works formed by each of these at either side of the machine tool.

The carriage portions 15 each extend marginally beyond the outer face of the trailing outer cover 29b so that the centre of gravity of the machine tool 11 is disposed within the bounds of the carriage portions. In this manner, the framework formed by the supporting legs 31 and the carriage portions 15 can support the remainder of the machine tool in a balanced manner.

The flange 33 of the annular bearing 19 has an annular portion 33a to which the leading side 29a of the outer cover is detachably mounted by a plurality of bolts and nuts 34, and a rectangular plate portion 33b to which the inner ends of the inner leg 35 and inner arms 37 are attached.

The main cylindrical part of the annular bearing 19 extends axially along the central axis 21 so that the ring journal 23 may be surmounted to the outside of the bearing with an appropriate bearing race interposed therebetween to enable rotation of the journal relative to the bearing.

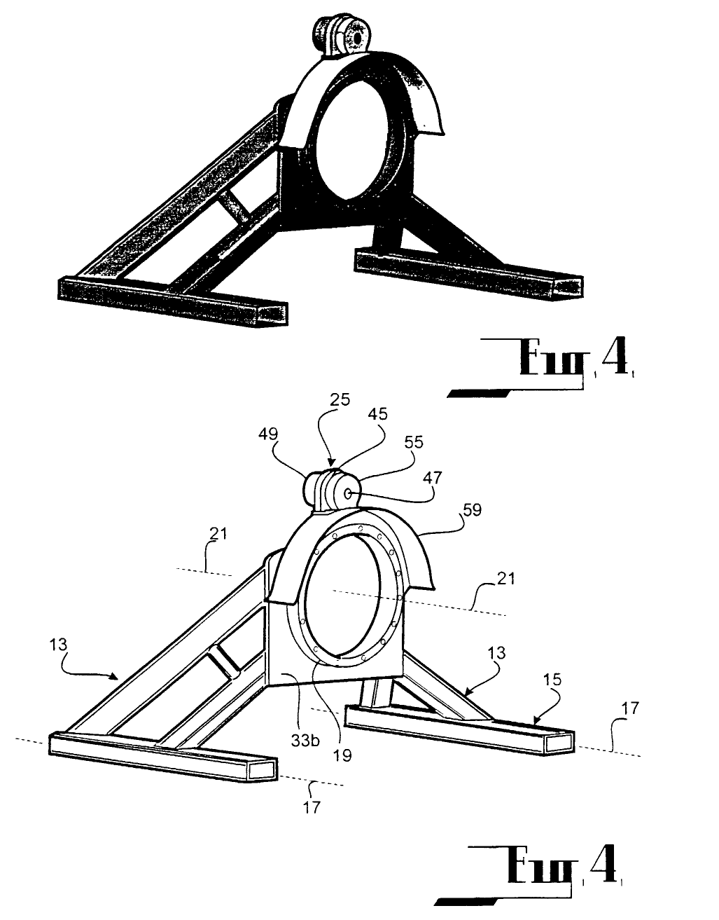

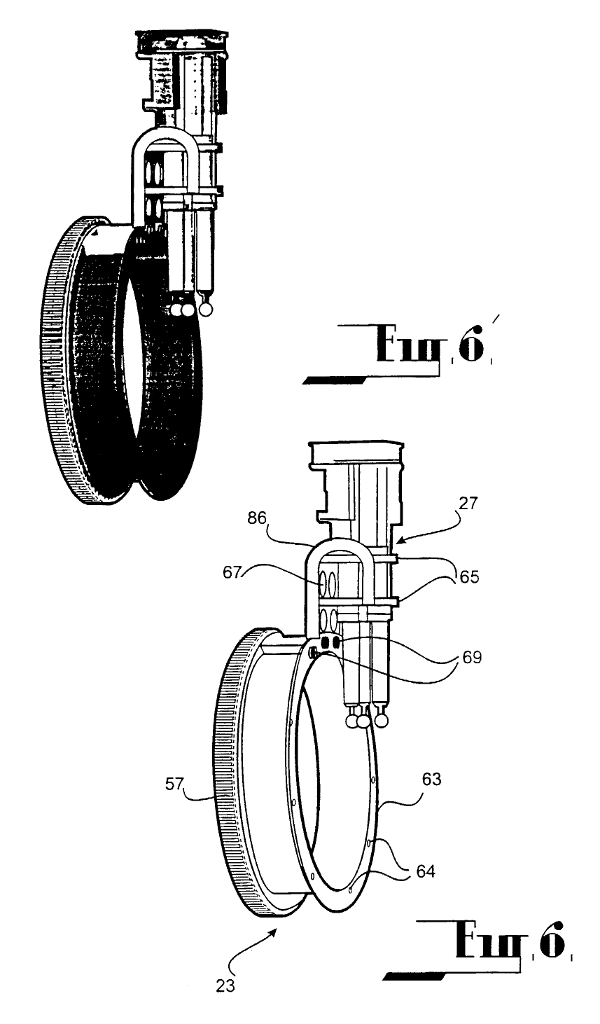

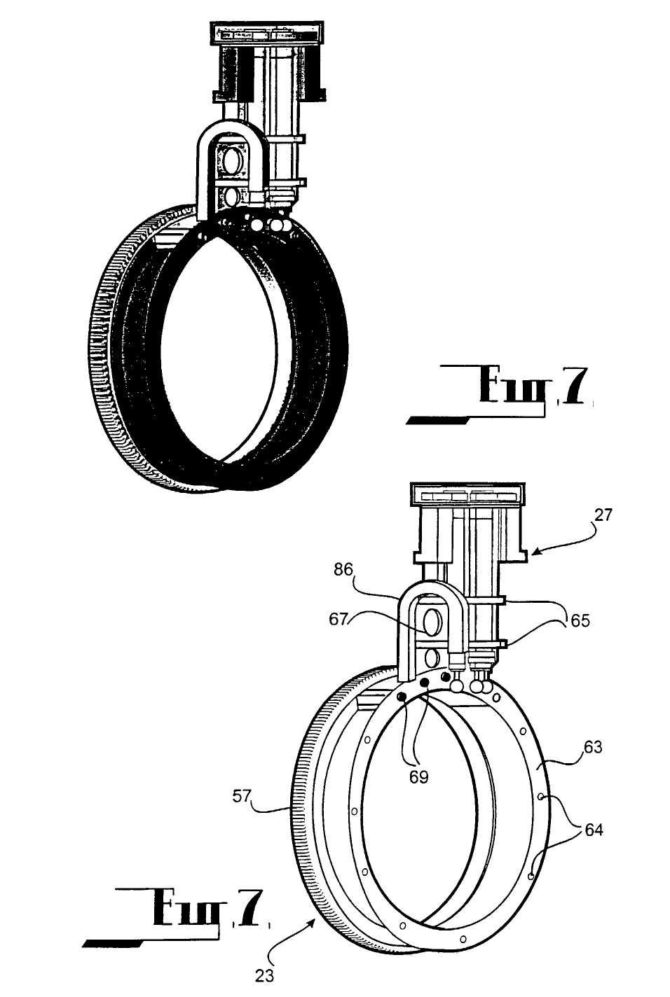

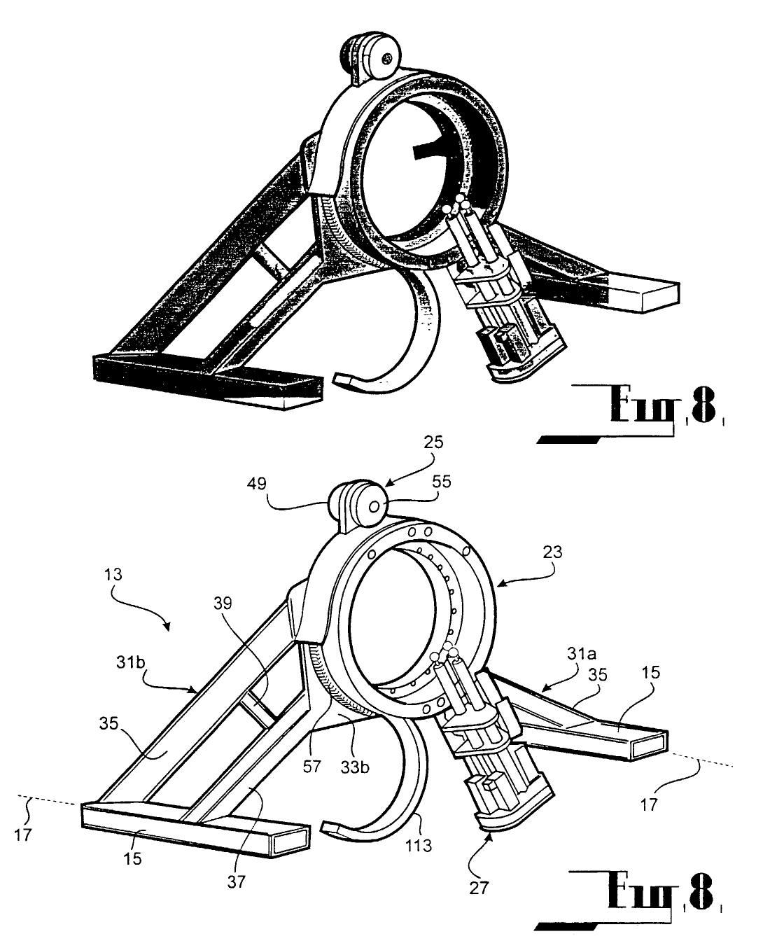

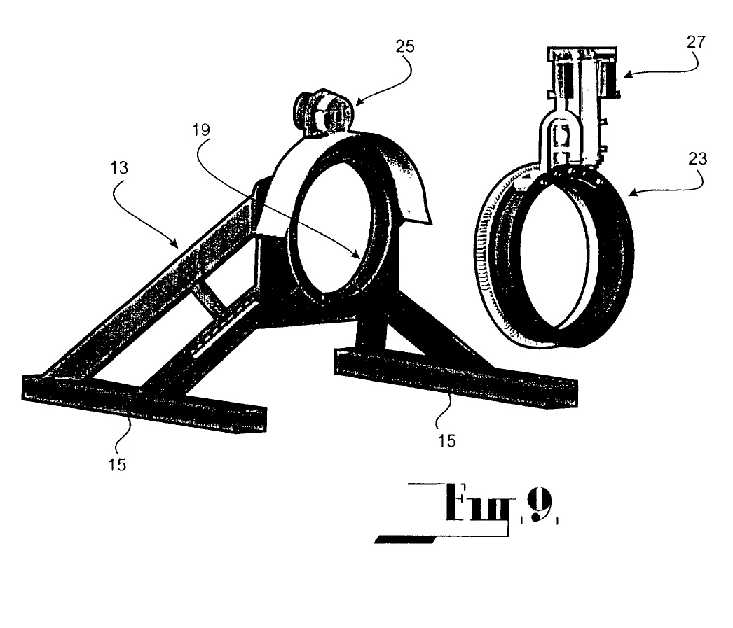

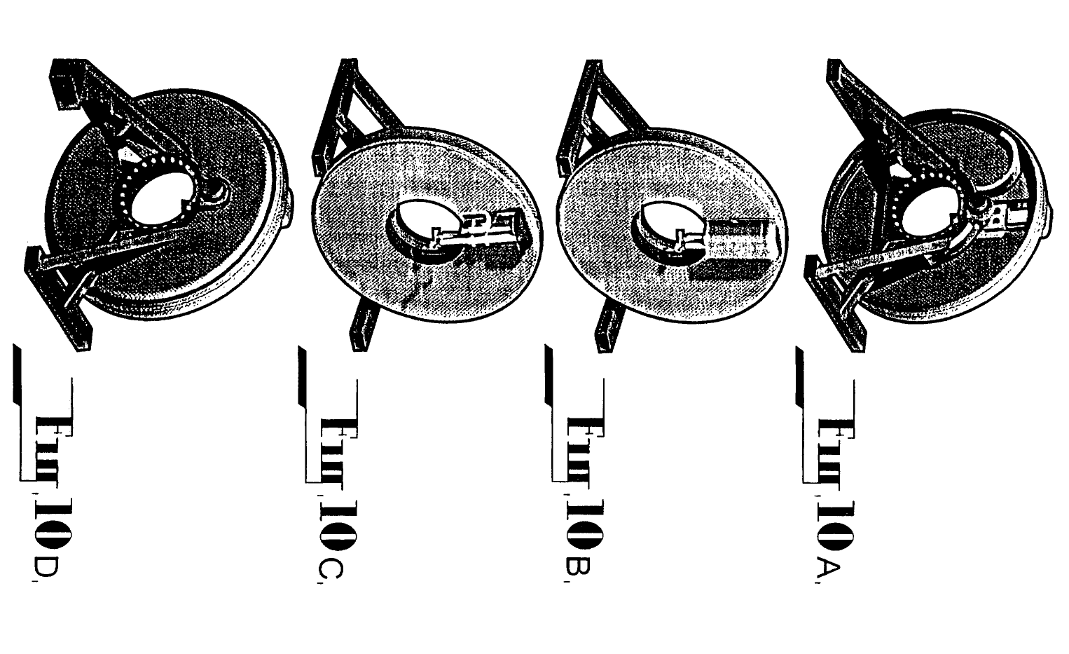

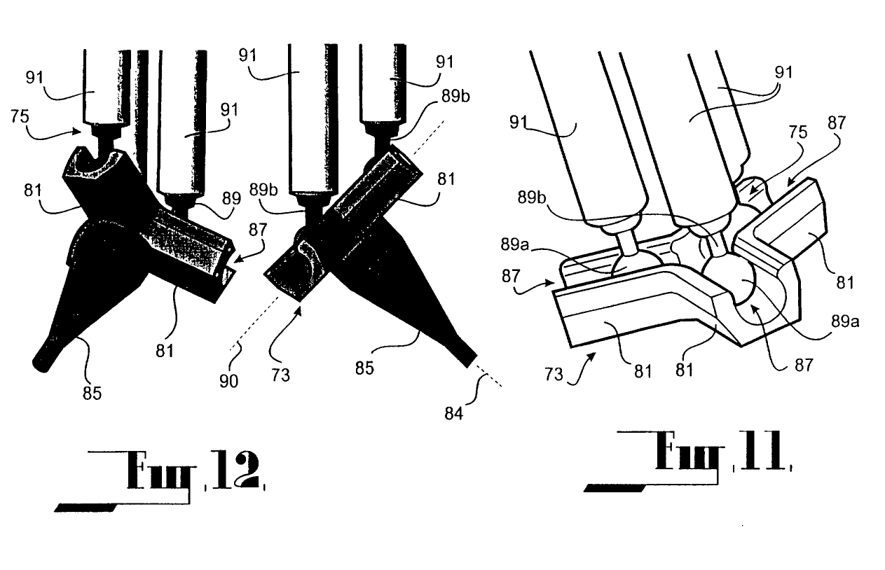

The positioning gearmotor 25 is fixedly mounted to the circular portion 33a of the flange by a bracket 45. The bracket 45 is disposed in coplanar relationship with the flange and projects outwardly therefrom relative to the central axis 21. The bracket 45 is provided with a central aperture in which the positioning gearmotor 25 is located transversely of the bracket so that the rotor 47 of the motor is disposed in parallel relationship to the central axis 21. The positioning gearmotor 25 is fixed to the bracket 45 by a circular mounting flange 53. The mounting flange 53 is affixed by a series of bolt or screw fasteners to the outside of the bracket 45, as shown in FIG. 5 of the drawings.

The outer end of the rotor 47 protrudes marginally beyond the outer face of the flange 33. Accordingly, the leading outer cover 29a is recessed around the bracket 45 in order to allow the rotor 47 to protrude outwardly therefrom. The outer protrusion of the rotor 47 is covered by an end cap 49 and terminals 51 for providing electrical power to, and directional control of, the positioning gearmotor 25 are disposed adjacent to the cap 49.

The inner end of the rotor 47 has a driving gear 55 fixedly mounted thereto to rotate in conjunction with the rotor and impart drive to the ring journal 23.

Accordingly, a computer control circuit (not shown) for operating the motor forms part of the computer control of the CNC machine and is connected to the terminals 51 to controlledly operate the positioning gearmotor 25 in accordance with machine control code programmed into the CNC.

The ring journal 23 is cylindrical and has a large outer driven gear 57 integrally connected therewith at its inner axial end, which is disposed adjacent to the flange 33 of the annular bearing 19 when surmounted thereon. The driven gear 57 is particularly disposed in position to intermesh with the driving gear 55 of the positioning gearmotor 25.

An axially extending shroud 59 is fixedly mounted to the inner side of the flange 33 to encase the top half of the driven gear 57 within the confines of the annulus formed by the outer cover 29 and prevent the ingress of dirt and dust into the teeth of the driven gear. A recessed opening 61 is provided in the top of the shroud 59 to allow the driving gear 55 to project there through and intermesh with the driven gear 57. The outer end of the journal 23 is also provided with a circular flange 63 to which the trailing outer cover 29b is fixedly attached by a plurality of bolts and nuts 64, in a similar manner to the attachment of the leading outer cover 29a to the flange 33. Accordingly, the circular flange 63 is disposed on the trailing side of the machine tool 11 and is in contiguous coplanar relationship with the trailing outer cover 29b.

The machine tool head 27 includes mounting means comprising a stock portion 65 to which the remainder of the head is attached and a head supporting member 67 connecting the stock portion to the ring journal 23. The head-supporting member 67 is essentially a radially extending bracket disposed in contiguous and coplanar relationship with the circular flange 63 and has a plurality of holes through which wiring to the machine tool head may be disposed and to which the stock portion 65 may be affixed. The head-supporting member 67 is fixedly attached to the inner side of a sector of the circular flange 63 at is proximal end by a plurality of bolt and nut fasteners.

The machine tool head 27, in addition to the mounting means, generally comprises a tool holder 73, a holder engaging means 75, holder orientating means 77 and a drive means 79.

The holder 73 comprises three radial arms 81 which are disposed in equi-angular relationship to each other about a central threaded aperture 83 for threadedly engaging a particular tool 85. In the present embodiment, the tool 85 is in the form of a plasma cutting head that is electrically powered. Suitable electrical wiring, directed to the inner end of the tool through the rear of the holder by a cable crook 86, provides electrical power to the tool 85. The transfer of power to the wiring will be described in more detail later.

The tool 85 projects outwardly from the outer side of the holder 83, coaxially of the aperture 83, and defines a tool axis 84. The arms 81 are of channel form, each being formed with a longitudinally extending groove 87. The grooves 87 are arranged in intersecting relationship at the proximal ends thereof and extend out longitudinally along each arm so that their axial ends of each groove are open at the distal ends of each arm. An acute sector of the longitudinal extent of each groove is open along the inner side of the holder 73 to define a discrete socket arrangement for attaching the holder 73 to the holder engaging means 75.

The holder engaging means 75 comprises three discrete finger connectors 89, each having a ball portion 89a and a shank portion 89b terminating in a threaded stem (not shown) the finger portions 89a engage and are retained within the socket formed by each of the groves 87. Each of the finger connectors 89 are screwed into corresponding holes provided at the bottom of three discrete cylinders 91, which form part of the holder orientating means 77. In this manner, a cylinder 91 and finger connector 89 are interconnected coaxially to form a fixed cylinder and finger pair, whereby the finger 89 is universally jointed to a corresponding arm 81 of the holder 73.

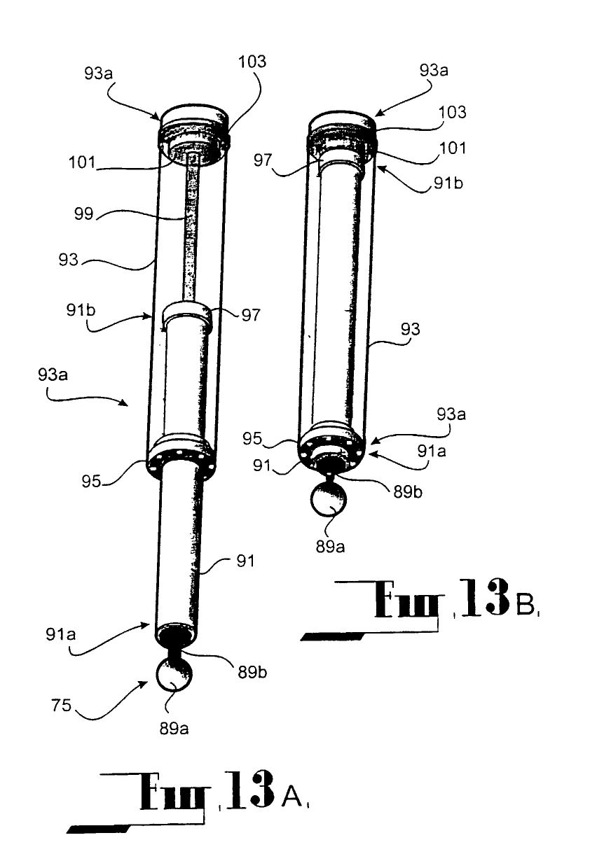

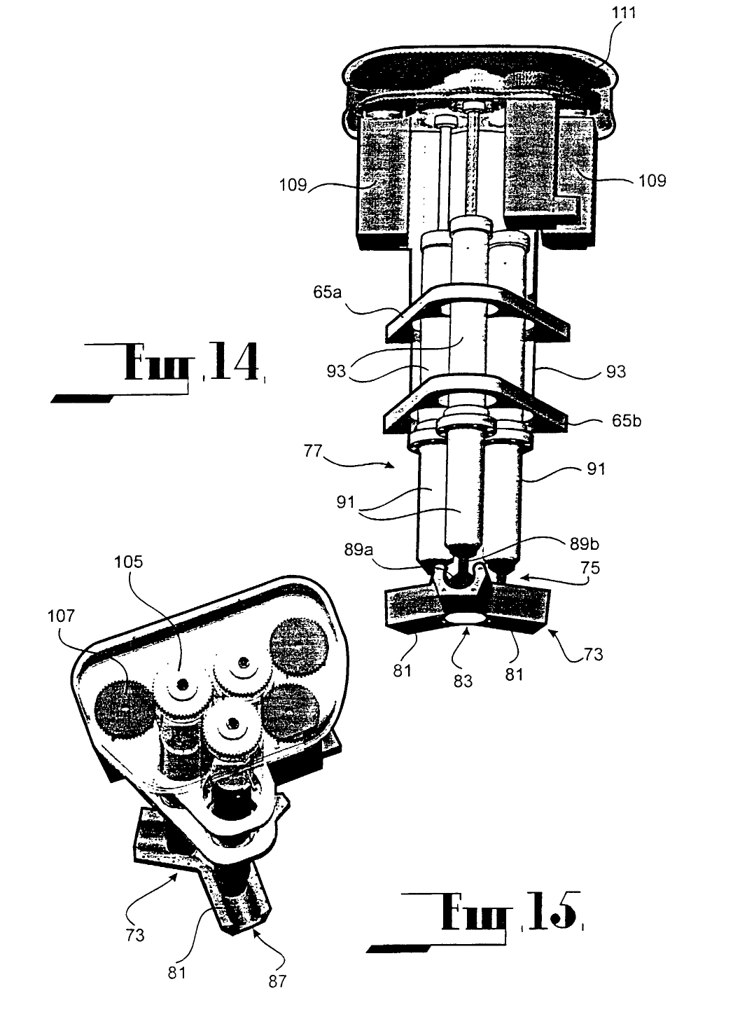

The arms 81 and grooves 87 therein are disposed in coplanar relationship with each other so that the holder 73 defines a main plane 90 coincident with the central axes of the grooves 87. Consequently, the tool 85 is always disposed in fixed orientation with respect to the main plane. In the present embodiment, this orientation is an orthogonal relationship as shown in FIG. 12B. Consequently, the ball portion 89a of each finger is universally jointed to the holder 81 so that the joints are disposed in coplanar relationship with the main plane 90.

The orientating means 77, in addition to the cylinders 91, includes a plurality of barrels 93, each barrel constituting a coaxial housing for a corresponding cylinder so that the cylinder may extend or retract relative to the barrel in a telescopic manner. The outer end 93a of each barrel is fitted with an annular retainer 95, which frictionally and slidably engages the outer surface of the corresponding cylinder 91 thereof. The inner end 91b of each cylinder has a retainer cap 97 fitted thereto having a threaded aperture therein to accommodate a screw shaft 99, which forms part of a screw drive of the drive means 79. The threaded shaft 99 is coaxially disposed and axially fixed within the barrel 93 so that rotation thereof causes axial movement of the cylinder 91 relative to the barrel 93.

The inner end of the screw shank 99 is fixedly connected to a circular screw head 101, which is journaled within a bearing 103, fitted to the inner end 93a of the barrel.

The drive means 79 comprises a gearing and screw drive incorporating the screw shaft 99 screw head 101 and a gearing arrangement comprising a driven gear 105 and a driving gear 107 connected to a servo motor 109. Thus, the drive means 79 comprises three discrete gearing and screw drives, each driven by a dedicated servo motor 109, a gearing arrangement comprising the corresponding driving gear 107 and driven gear 105, a corresponding screw head 101 and screw shaft 99. Each corresponding screw shaft 99, screw head 101 and driven gear 105 is coaxially aligned with respect to the corresponding barrel 93 and cylinder 91.

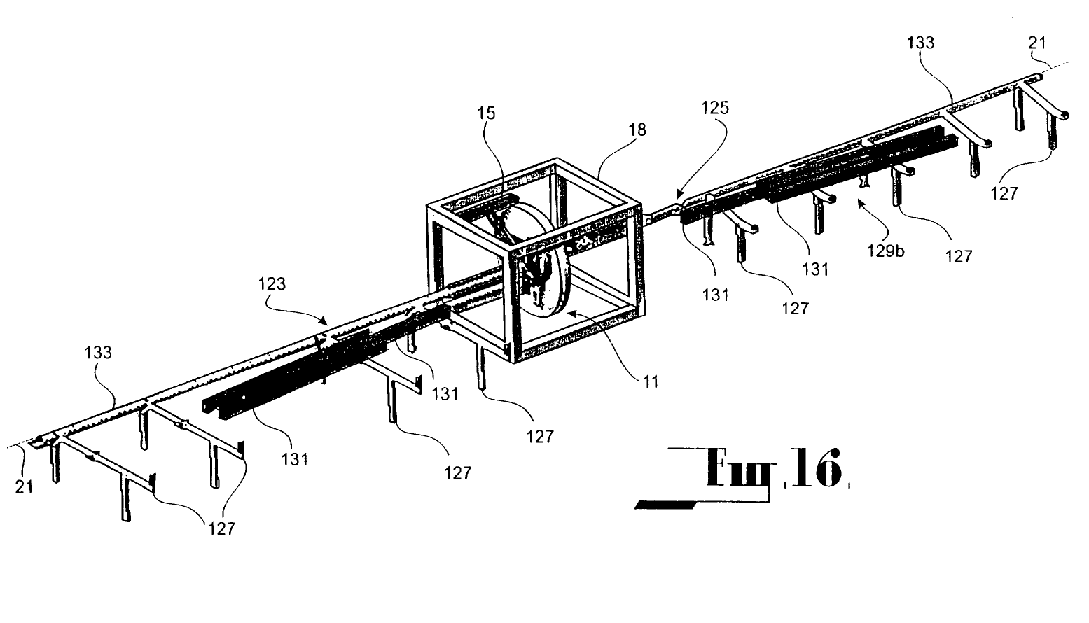

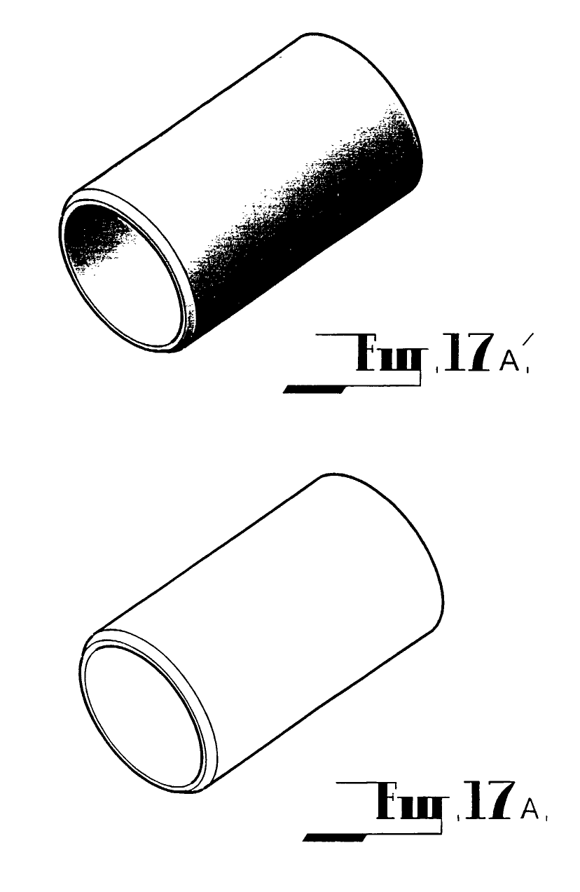

The corresponding driving gear 107 is disposed laterally of the driven gear 105 and is coaxially aligned with the corresponding servo motor 109 so that the servo motor is disposed in parallel and adjacent relationship to the corresponding barrel 93 as shown in FIG. 14.

The gearing arrangement is disposed in a removable casing 111 to protect the gearing and screw drive of each cylinder and finger pair from the surrounding environment, and prevent the ingress of dirt and dust.

The stock portion 65 of the machine tool head 27 comprises a pair of triangular brackets 65a and 65b, which are fixedly attached to the head-supporting member 67 of the mounting means.

The brackets 65a and 65b are each provided with three holes, one for each barrel 93 and are axially spaced apart so that corresponding pairs of holes are coaxially aligned to accommodate corresponding barrel 93 therein. Each barrel 93 is fixedly retained within each hole so that the barrels are disposed in fixed parallel relationship to each other.

The servo motors 109 are separately controlled via control circuitry (not shown) delivered by control wires connected to a plurality of corresponding terminals 69 mounted to the outside of the circular flange 63.

Electrical power is transferred to the terminal 69 through fixed, but flexible cables carried in a cable chain 113. These flexible cables include the control wires referred to above. The machine tool 11 is prevented from continuously rotating the ring journal 23 and machine tool head 27 by software and physical hardware means. Accordingly, the machine tool is particularly programmed to perform a high speed “uncoil” sequence after each cut so that no slip ring or other sliding conduction means is necessary.

The machine tool 11, as described, is suspended via the carriage portions 15 to the track (not shown) provided on the sub-frame 18, as shown in FIG. 1 of the drawings. The carriage portions 15, and consequently the remainder of the machine tool 11, may be moved axially along the track axis 17 and the central axis 21 by a precision advance and retract mechanism (not shown) mounted to the sub-frame. The sub-frame itself is fixed to a table (not shown) provided with an in-feed conveyer system 123 on the leading side of the machine tool 11 and an out-feed conveyer system 125 on the trailing side of the machine tool 11. The conveyer systems are supported on a plurality of stands 127 and have respective in-loading and out-loading stations 129a and 129b associated therewith at opposite sides of the machine tool 11. These loading stations and conveyer feed systems are of conventional design and will not be described further.

As previously described, the metal sections treated by the machine tool 11 can be of a number of different types. As shown in FIGS. 1 and 16, the metal section is an I-beam 131, but as shown in FIGS. 2 through to 3′ and FIG. 16, the metal section can also be circular tubing 133.

Now describing the method by which an object in the form of a metal section is worked or has a material treatment applied thereto, initially the section dimensions and the operations that are required to be performed by the machine tool 11 are determined.

Next a tool or tools that are necessary to suit and perform the operation or operations that are required are selected. The tool, for example the plasma cutting tool 85, are made ready for attachment to the tool holder 81. The selection and attachment procedure may be automated using mechanisms that are known in the art of CNC machines.

After this is determined, the dimensions of the section, a description of the operations required and the relevant tools necessary are entered into the computer control system (not shown) of the CNC using an appropriate machine language for the CNC.

For example, appropriate machine control code may be generated using a computer file, such as a three-dimensional solid file, that in turn may be generated by using image translation software such as of the type described in the complete specifications of Australian patent application 48716/96 and 59391/99.

All of this may be undertaken on a separate computer system such as a PC loaded with the appropriate software. On completing the generation of the machine control code, the machine control code is downloaded into the computer control system of the CNC to effect the material treatment operation thereafter.

The initialisation of the CNC with the computer control code is then undertaken and the appropriate metal sections are set up of in the in-loading station 129a, ready for placement onto the in-feed conveyor system 123 and feeding to the working area of the machine tool 11.

The feeding operation is commenced by the first metal section to be treated being advanced by the in-loading station to situate on the in-feed conveyor 123. The section is then advanced along the conveyor 123 towards the leading side of the machine tool 11.

A device (not shown) on the machine tool 11 detects the front edge or other known position or reference point on the advancing metal section 131 and sets the CNC to commence the material treatment. Thereafter, the CNC takes over direct control of the in-feed conveyor 123 and advances the section to the position at which the first operation of the material treatment has been programmed to commence.

The section is secured in this position and the precision advance and retract mechanism, which drives the machine tool 11 along the track provided on the sub-frame 18, is engaged.

The computer control system of the CNC determines the speeds and positions or travel path of the tool 85 in accordance with the machine control code programmed into the CNC.

The tool then starts and advances to the section, or alternatively the tool is advanced to the section first and then started. This movement of the machine tool 11 relative to the section is in a lineal direction along the central axis 21 of the tool and denotes the first axis of movement of the machine tool.

The first treatment operation is then undertaken and the machine tool carries out the required operation in accordance with the machine control code.

During this operation, the precision advance and retreat mechanism, positions the material and/or the tool relative to the material as needed to complete the axial treatment operations on the section.

Whilst performing these operations, the tool 85 or tools will usually be rotated around the central axis 21 by controlled operation of the journal drive means 25 to rotate or counter-rotate the ring journal 23 within the annular bearing 19 relative to the base 13 of the machine tool. Rotation of the ring journal 23 results in direct rotation of the machine tool head 27 and thus the tool 85 about the section. This rotation of the tool denotes the second axis of movement of the machine tool.

It should be noted that the tool 85 can move from the outside of the ring, to the centre or to the opposite side of the ring so as to circumscribe the section at any position within a full 360° rotation of the section.

In addition to such rotation of the tool relative to the section, the radial position of the tool to any particular point within the ring can be adjusted in three-dimensional space This is achieved by controlledly retracting or extending any one or more of the cylinders 91 of the machine tool head 27 relative to their corresponding barrel 93. This results in the radial distance between the tool head and a point on the cylinder being continuously changeable, providing a third axis of movement.

The relative angular position of the tool axis 84 of the tool 85 is also alterable relative to the longitudinal axis of the machine tool head 27, which is radial to the central axis 21 of the machine tool 11. by appropriate extension and/or retraction of appropriate cylinders 91 with respect to corresponding barrels 93, the tool can be continuously alterable about this longitudinal axis in at least one plane, providing a fourth axis of movement.

Finally, the tool, at any such angular position adopted relative to the longitudinal axis can altered within a further plane of movement, providing a fifth axis of movement.

Indeed a sixth axis of movement can be provided by rotating the tool about its tool axis 84, in any of the adopted orientations of the tool relative to the longitudinal axis of the machine tool head 27.

An important advantage of the present embodiment is that, whilst a tool may be moved to rotate about the central axis 21 of the machine tool, its radial distance from such axis can be controlled continuously so as to enable the tool to follow the contour of the section and simultaneously maintain the tool at the desired angular position with respect to the material treatment being performed on the section.

Further, the tool 85 at any time can be angled in either direction in the plane of the section of travel, and at the same time the tool can be angled in either direction in the plane of the cut or treatment being performed, or at any angle in between.

Thus, the particular arrangement of the machine tool head 27 essentially provides for three axes of movement of the holder 81 and hence the tool 85. This allows for precise control of, and complete dexterity in, the movement of the holder and tool with respect to pitch, back and extension, relative to the main axis 21 of the machine tool.

As a result of such flexibility and dexterity of movement, the following operations may be performed:

1. cutting the metal section to length;

2. cutting the metal section in a mitre or compound mitre;

3. cutting a bevel joining the outside of the inside surface of the metal section or both;

4. cutting holes or slots of any shape in the metal section at any point along its length;

5. cutting notches in the ends of the metal section of any shape.

It should be appreciated that the particular embodiment described, and hence the invention, has many significant advantages over prior art machine tools. For example, the particular material treatment that can be performed can be varied to include: marking, painting, coating or depositing any material on an object, measuring finish, abrading, electrode discharging, magnetising or demagnetising, chemical treatment, cleaning or washing, exposing to light or radiation, hardening, annealing, heating or cooling, fastening, threading, drilling, milling and indeed any standard machine function, punching, piercing, ultrasonic measuring or treating, radiating etc.

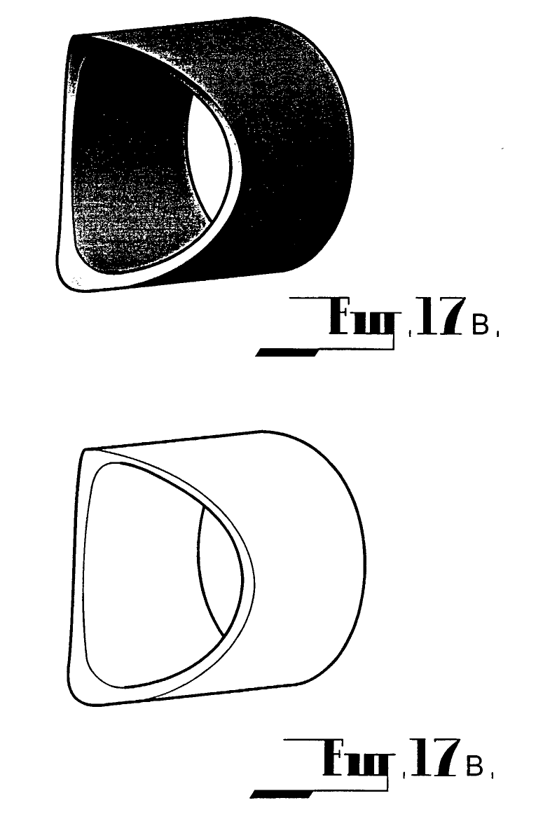

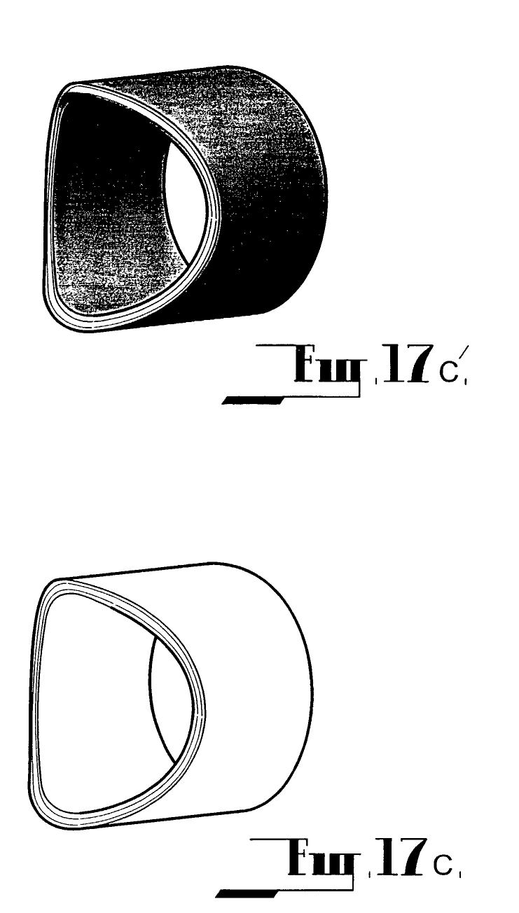

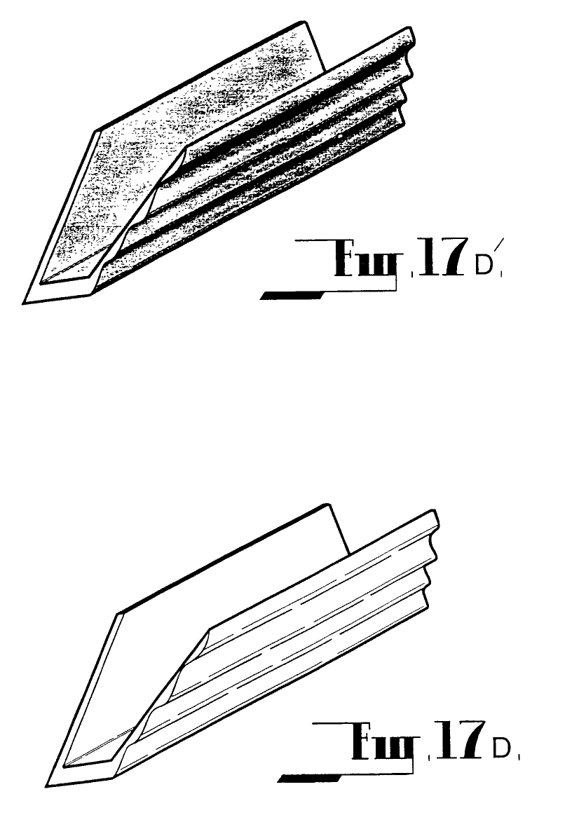

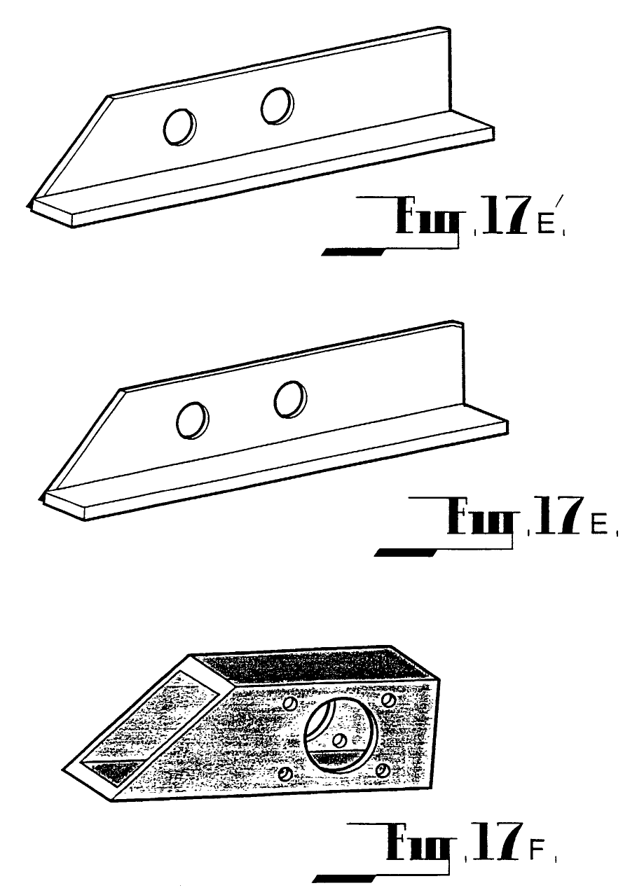

Examples of the different types of sections that may be treated by complex cutting are shown in FIGS. 17A through to 17F.

It should also be appreciated that the particular invention is not limited to the specific embodiment herein described. For example, other embodiments may be readily designed having a plurality of machine toot heads and not just the one.

Furthermore, the machine tool can have various accessories added to it that extend its functionality and capability. For example, a cutting table that presents any loaded material size to the machine tool at any time could be provided. In addition, an off-cut recycling system can be provided to retrieve, store and present off-cuts to be reutilised by the machine tool to suit the next specified material treatment or operation performed by the CNC. This would eliminate or minimise unnecessary waste.

Alternative embodiments may involve the use of a packing table that can position and process sections in a way that benefit the next operation to be performed on the material. This may include a pick and place mechanism that can perform other operations on the sections, or position the sections in an assembly, or pack the sections for transport.

Further a computer based ordering and despatching system can be incorporated into the design of the CNC and machine tool, that enables an order to be retrieved, processed and have resultant treated sections packed for despatch.

The machine can also be designed to operate for extended periods without supervision or attendance by personnel. Further still, the machine may permit electronic access by hardware or wireless interface for operation, diagnostics, reporting, maintenance and upgrade.

The claims defining the invention are as follows:

1. A machine tool head for working on an object comprising:
a holder for a tool to be connected to the machine tool head that works the object;
a holder engaging means for engaging and supporting said holder in a variety of orientations relative to a main axis or plane of the object;
orientating means for changing the position of said holder engaging means so as to orient said holder relative to said main axis or plane in any of said orientations;
drive means for driving said orientating means and varying the orientation of the holder in a controlled manner; and
mounting means for mounting the machine tool head to a head supporting member.

2. A machine tool head as claimed in claim 1, wherein said holder is formed to define a main plane and has a tool connection for connecting a tool thereto in fixed orientation to said main plane; and said holder engaging means comprises a plurality of fingers each universally jointed to said holder so that the joints are disposed in coplanar relationship with said main plane.

3. A machine tool head as claimed in claim 2, wherein said orientating means comprises a plurality of cylinders and barrels one for each said finger, to axially move a said finger independently of the other, relative to said barrels.

4. A machine tool head as claimed in claim 3, wherein a corresponding barrel and cylinder pair are disposed in coaxial relationship with each other and a corresponding finger, and all of said pairs are disposed in parallel relationship with each other.

5. A machine tool head as claimed in claims 3 or 4, wherein said drive means comprises a gearing and screw drive driven by a dedicated servo motor for each pair, each said servo motor being individually and precisely controlled to rotate or counter-rotate a screw shaft via gearing to axially extend or retract a said finger and cylinder relative to a said barrel thereof.

6. A machine tool head as claimed in any one of claims 3 to 5, wherein there are three pairs of corresponding fingers, cylinders and barrels providing three axes of movement of said holder (and hence the tool), allowing for precise control of, and complete dexterity in, the movement of said holder with respect to pitch, bank and extension relative to said main axis.

7. A multiple-axis machine for working on an object comprising:
a base housing an annular bearing having a central axis along which an object to be worked on may be disposed;
a ring journal, concentrically and rotatably disposed within said bearing to be rotated or counter-rotated relative to said bearing;
journal drive means mounted to said annular bearing to engage and controlledly drive said ring journal in rotation or counter-rotation relative to said bearing;
a machine tool head having a holder for a tool to be connected thereto for working an object, said machine tool head being fixedly mounted to said ring journal so that the holder is disposed radially of said ring journal to present the tool for performing a material treatment of the object, when the object is disposed with its main axis coaxial with said central axis, at an orientation to the surface of the object prescribed by said orientation means.

8. A multiple-axis machine as claimed in claim 7, wherein the ring journal has a driven gear portion circumferentially disposed at one end thereof and said journal drive means has a driving gear portion intermeshing with said driven gear portion to effect said rotation or counter-rotation of said ring journal relative to said bearing.

9. A multiple-axis machine as claimed in claim 7 or 8, wherein said base is mounted to a carriage axially moveable along a track axis, whereby the track axis is parallel with the central axis of said bearing.

10. A multiple-axis machine as claimed in any one of claims 7 to 9, including an object feeding means to support the object with its main axis coincident with said central axis, and move said object axially along the main and central axis relative to said base.

11. A multiple-axis machine as claimed in any one of claims 7 to 10, wherein said machine tool head is as claimed in any one of claims 1 to 6.

12. A method for working an object having a main axis to provide a material treatment thereof comprising:
disposing the object so that its main axis is coincident with a central axis about which the material treatment is performed;
holding a tool to perform the material treatment at a prescribed radial orientation relative to the object and the main and central axes;
moving the tool relative to said object around the entire circumference of the object as necessary in a direction transverse to said central axis; and
continuously varying the orientation of the tool relative to the object in accordance with a predetermined control program as necessary to effect the material treatment.

13. A method as claimed in claim 12, wherein the tool is oriented in three-dimensional space having three-axes of movement permitting precise control of, and complete dexterity in, the movement of the tool in its radial disposition relative to the object with respect to pitch, back and extension.

14. A method as claimed in claim 13, wherein the tool is further oriented in three-dimensional space having two further axes of movement relative to the object, one being rotational so that the tool may entirely circumscribe the object about said central axis and the other being rectilinear, parallel to said central axis, so that the tool may traverse the surface of the object axially relative to its main axis.

15. A machine tool head for working on an object substantially as herein described with respect to the accompanying drawings as appropriate.

16. A multiple-axis machine for working on an object substantially as herein described with respect to the accompanying drawings as appropriate.

17. A method for working an object substantially as herein described with respect to the accompanying drawings as appropriate.
